(19) United States
(12) Patent Application Publication
(10) Pub. No.: US 2018/0093294 A1
(43) Pub. Date: Apr. 5, 2018

(54) PORTABLE INLINE PARTICULATE COATING

(71) Applicant: TRICAN WELL SERVICE LTD, Calgary (CA)

(72) Inventors: Scott SHERMAN, Blackie (CA); Bill O'NEIL, Calgary (CA); Kurt LUCAS, Calgary (CA); Kewei ZHANG, Calgary (CA)

(21) Appl. No.: 15/721,251

(22) Filed: Sep. 29, 2017

Related U.S. Application Data
(60) Provisional application No. 62/402,787, filed on Sep. 30, 2016.
(60) Provisional application No. 62/533,511, filed on Jul. 17, 2017.

(51) Int. Cl. B05C 5/02; B05D 1/02

(52) U.S. Cl. CPC B05C 5/0208; B05D 1/02

(57) ABSTRACT

Apparatus and methods for coating particulates to suppress dust and/or modify the behavior of the particulate, spray the coating onto the particulate as it moves along inclined surfaces within the coater apparatus. The coating is sprayed generally as a mist and the particulates remain free-flowing throughout the apparatus and when discharged therefrom. Apparatus using a single spray step and subsequent transfer coating steps to effect particulate-to-particulate transfer of coating achieve at least about 75% coating of the particulate. Embodiments of the apparatus with dual spray steps and without the subsequent transfer coating steps are capable of achieving at least 85% coating of particulates with a single pass through the apparatus.

### CROSS-REFERENCE TO RELATED APPLICATIONS

This application claims the benefit of U.S. Provisional Patent Application Ser. No. 62/402,787, filed on Sep. 30, 2016, and of U.S. Provisional Patent Application Ser. No. 62/533,511, filed on Jul. 17, 2017, the entirety of each of which is incorporated herein by reference.

### FIELD

Embodiments relate to apparatus and methods for coating particulates with a generally liquid composition and, more particularly, to coating of particulates, including but not limited to proppants, such as for dust control, modification of particulate behavior and the like.

### BACKGROUND

It is known to apply a coating to particulates for a wide variety of uses, including, but not limited to use as an abrasive, such as in sand blasting, in foundries, and for use as proppants in the oil and gas industry. In the case of proppants, the particulates can be sand or other suitable materials, such as ceramic beads. The proppants are generally coated to modify the behavior of the proppant when in use, such as to suspend the proppant in a fracturing fluid, to reduce hazardous dust production when handled prior to use, or both.

Dust, produced during handling of materials such as sand, has long been recognized as being problematic. Illnesses such as silicosis, lung cancer, tuberculosis in patients with silicosis and chronic obstructive pulmonary disease (COPD) are caused by exposure to respirable crystalline silica, such as found in sand. Other illnesses such as kidney disease and other cancers are also related. While personal protective equipment is available for workers handling sand and other silica containing materials, this does not affect the cause. Coating of sand with a suitable coating attempts to directly address the production of dust during handling.

Coatings are also known to increase the functionality of sand or other proppants, used for fracturing, sand blasting, construction and other purposes. In the case of proppants used for fracturing a formation, the coatings may increase hydrophobicity, transportability of the proppant in the fracturing fluid, consolidation, compressive strength and permeability/conductivity, as well as acting to control dust when handled. Applicant provides a variety of chemical compositions as liquid coatings used to modify proppant by transmitting a hydrophobic coating onto the proppant surface, making the proppant more buoyant, without increasing fluid viscosity. The resulting, easily-fluidized proppant is more readily transported in the formation for increasing the propped fracture height and length which results in increasing overall conductivity of the formation.

Coatings are generally applied by spraying the coating composition onto the proppant as it is transported on a conveyor or through an auger. Coatings are also known to be applied by adding sand and the coating composition to a batch mixer and agitating therein to mix the slurry.

Sand plants are known to have used spray bar attachments to spray chemical coatings onto sand transported passively along transfer belts before the sand enters rollers, tumblers and dryers. Generally, the spray bar attachments coat one side of the sand only, resulting in 100% of the coating being applied to 50% or less of the sand surface area.

With respect to batch mixing processes, while generally better at coating a larger percentage of the sand surface, batch processes are generally inefficient for large volume requirements, such as downstream fracturing operations. Further, such processes are generally wet processes and may require drying time to ensure the sand is free-flowing following the coating process, which adds to the overall inefficiency in meeting supply demands.

There is interest in mobile, easily transportable apparatus and processes for efficiently coating particulates, such as sand, in an inline process to supply sufficient, freely-flowing, effectively coated particulates to meet downstream needs.

### DESCRIPTION OF DRAWINGS

FIG. 1 is a cross-sectional view of a prior art coating apparatus, designed for coating seed;

FIG. 2 is a cross-sectional view of an embodiment of a system having a conical inclined surface and one or more spray nozzles for performing a spray step in a coating process according to an embodiment taught herein;

FIG. 3 is a cross-sectional view of an embodiment of a system having a planar inclined surface and one or more spray nozzles for performing a spray step in a coating process according to an embodiment taught herein;

FIG. 4A is a cross-sectional view of the system of FIG. 2 discharging coated particulate to an embodiment of a second transfer coating step;

FIG. 4B is a cross-sectional view of the system of FIG. 2 discharging coated particulate to the embodiment of the second transfer coating step of FIG. 4A;

FIG. 5A is a cross-sectional view of the system of FIG. 2 discharging coated particulate to an embodiment of a second transfer coating step;

FIG. 5B is a cross-sectional view of a system of FIG. 3 discharging coated particulate to the embodiment of the second transfer coating step of FIG. 4A;

FIG. 6A is a cross-sectional view of an embodiment of apparatus having a first inclined conical surface and one or more first spray nozzles for performing a first spray step and discharging to a second inclined conical surface for performing a second, transfer coating step of an embodiment of a coating process,

FIG. 6B is a cross-sectional view of an embodiment of apparatus having a first inclined planar surface and one or more first spray nozzles for performing a first spray step and discharging to a second inclined planar surface for performing a second, transfer coating step of an embodiment of a coating process, the apparatus having one or more optional second spray nozzles for applying an optional second spray step during the transfer coating step;

FIG. 7A is a cross-sectional view of an embodiment of apparatus having a first inclined conical surface and one or more first spray nozzles for performing a first spray step and discharging to a second inclined conical surface for performing a second, transfer coating step of an embodiment of a coating process;

FIG. 7B is a cross-sectional view of an embodiment of apparatus having a first inclined planar surface and one or more first spray nozzles for performing a first spray step and discharging to a second inclined planar surface for performing a second, transfer coating step of an embodiment of a coating process, the apparatus having one or more optional second spray nozzles for applying an optional second spray step during the transfer coating step;

FIG. 8A is a perspective view of an embodiment having first and second inclined conical surfaces and first and second spray nozzles for applying first and second spray steps, without a transfer coating step;

FIG. 8B is a side view according to FIG. 8A;

FIG. 8C is a cross-sectional view along lines A-A of FIG. 8B; and

FIG. 8D is a partial cutaway view according to FIG. 8A, a section of a housing and a conical distributor, supported therein, having been removed for clarity of the spray set-up in the housing and below the distributor.

### SUMMARY

Embodiments of apparatus and methods for coating particulates in an in-line process utilize inclined planar or conical surfaces to move the particulates downwardly therealong in a first direction, such as on a first inclined surface and then downwardly therealong in a second direction, such as on a second inclined surface. A liquid coating is directed to the first and second inclined surfaces, such as by spraying, onto the particulate as it moves downwardly thereon. The liquid coating is generally sprayed as a mist. The liquid coating is applied at a rate that maintains the particulates free-flowing through the apparatus and thereafter. Coated particulates discharged from the apparatus achieve a coating of greater than 75% and more particularly greater than 85% at throughput rates suitable for downstream operations, such as to meet the needs of a fracturing operation in the oil and gas industry or a sand or grit blasting operation.

In one broad aspect, embodiments of apparatus for coating particulates with a liquid coating comprise a first inclined surface for receiving the particulates distributed thereon from a feed thereto. The particulates moving downwardly therealong in a first direction away from the feed. One or more first sprays direct a portion of the liquid coating onto the first inclined surface for coating at least a portion of the particulates moving in the first direction therealong. A second inclined surface receives the partially coated particulates discharged from the first inclined surface and moves the particulates downwardly therealong in a second direction toward the feed. One or more second sprays direct a balance of the liquid coating onto the second inclined surface for coating at least a portion of the particulates moving in the second direction therealong for discharge of free-flowing, coated particulates from the second inclined surface. The liquid coating is delivered to the particulates at a flow rate of between about 0.03 wt % to about 0.15 wt %.

In another broad aspect, a method of coating particulates with a liquid coating comprises feeding the particulates onto a first inclined surface for distributing the particulates thereon, the particulates moving downwardly therealong in a first direction away from the feed. At least a portion of the particulates is coated with the liquid coating as the particulates move downwardly along the first inclined surface. The particulates are discharged from the first inclined surface to a second inclined surface for moving the particulates downwardly therealong in a second direction toward the feed. At least a portion of the particulates are coated with the liquid coating as the particulates move downwardly along the second inclined surface for discharge therefrom, greater than about 75% of the particulates being coated.

In embodiments, the particulates are coated by spraying the liquid coating onto the first and second inclined surfaces as the particulates are moving downwardly therealong. The liquid coating is applied to the particulates at a flow rate of between about 0.03 wt % to about 0.15 wt %.

In embodiments taught herein, the particulates remain free-flowing through the apparatus and after coating therein. Coated particulates are discharged from the apparatus at a rate of from about 2 tonnes/min to about 6 tonnes/min. Greater than about 75% of the particulates are coated. In embodiments, where the rate of discharge from the apparatus is from about 2 tonnes/min to about 3 tonnes/min, greater than about 85% of the particulates are coated.

Where the particulates are proppant, and more particularly sand, for use in a fracturing operation in the oil and gas industry, the throughputs are sufficient to meet the typical bulk sand loading requirements of from about 2 tonnes/min to about 6 tonnes/min.

Further, when particulates, such as sand, used in a variety of industries are coated with a liquid coating, such as a hydrophobicizing composition, according to embodiments taught herein, dust generated therefrom is suppressed by about 85% or greater.

### DETAILED DESCRIPTION

Embodiments taught herein provide relatively simple, cost effective apparatus and methods for coating particulates with a generally liquid, sprayable coating composition. Coatings designed to improve functionality of the particulates may also act to minimize dust. Further, more than one coating composition may be required to achieve the desired functionality of the particulates, to minimize dust or both. In embodiments, one or more coatings may be applied during the inline coating process as is required.

To minimize dust formation and hazards associated therewith, the particulates, such as sand, are generally treated to apply the coating as early as possible in the handling process. In embodiments, sand is coated at a standard sand transfer point, such as when the sand is off-loaded from rail cars used to transport the sand from a vendor or mine site, or as sand is removed from a storage location for transport to a wellsite. Once coated according to embodiments taught herein, hazards from dust are substantially mitigated during further inline transport and handling to locations where the sand is stored and/or used for fracturing operations, in the handling at the wellsite or for sand-blasting or grit-blasting and the like.

### Prior Art Coating Apparatus

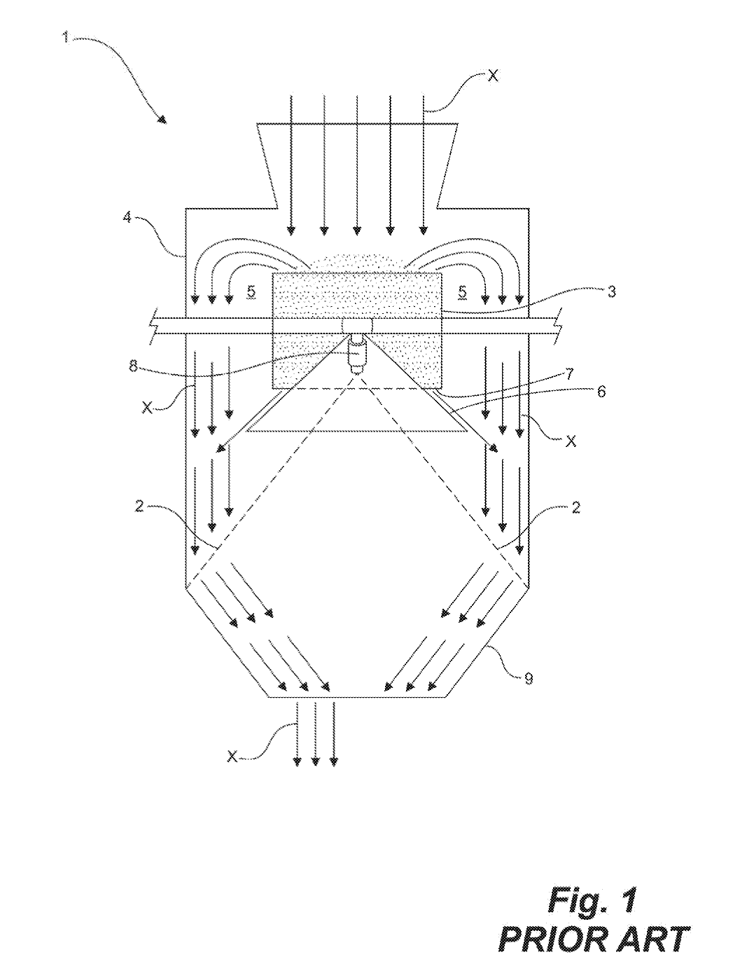

Having reference to FIG. 1, it is known to coat seed with coatings such as fungicides, insecticides, inoculants and the like using a prior art apparatus 1 as taught in Canadian Patent 2,196,001 to Graham. The seed X is dispersed into a curtain of seed falling within the apparatus 1, the seed falling therein through a controlled conical spray 2 of a coating.

A cylindrical retarder 3, suspended within a hollow housing 4, forms an annular space 5 between the retarder 3 and the housing 4. A conical restrictor 6 is spaced below the bottom of the retarder 3 to form an annular gap 7. The annular gap 7 is purposefully limited in size to prevent a majority of the seed X to pass downwardly therethrough, causing the seed X to accumulate in the retarder 3 above the restrictor 6. Seed X, spilling over the top of the retarder 3, is directed to the annular space 5 and falls through the housing 4 as a curtain of seed X. Only a portion of the seed X flows continuously downward through the annular gap 7 and into the housing 4 to join the curtain of seed X falling therein.

A spray nozzle 8 is located below the restrictor 6 for spraying a downwardly directed, hollow conical pattern outwardly toward the housing 4 to contact the curtain of seed X falling therein. The conical spray pattern intersects the seed X, at a diagonal thereto. A conical discharge 9 intercepts the coated seed X and delivers the coated seed X for discharge from the apparatus 1.

Graham specifically teaches away from use of multiple nozzles to spray the coating or reliance on contact between the seeds to provide even coating of the seed.

In a video, viewable online at the following URL, https://www.youtube.com/watch?v=899VwR9MyRE, Graham teaches that coating of the seed using the prior art apparatus alone is insufficient to fully coat the seed. An auger used to lift the seed from a hopper in which the discharged coated seed is collected provides sufficient mixing to fully coat the seed.

Applicant believes the apparatus of Graham, designed to deliver a volume of about 20 bushels of 85% coated seed per minute, is insufficient to meet the downstream needs for coated particulates as contemplated herein and particularly in the case of coating proppant to be used in a fracturing operation. Sand bulk loading for fracturing operations typically require from about 2 to about 6 tonnes per minute.

Applicant has tested merely increasing the size of the prior art Graham apparatus however it was still insufficient to achieve the downstream flow rates and coating requirements for which embodiments taught herein have been designed.

Further, as discussed below, a requirement to rely on a transfer auger or other transfer apparatus to achieve a design percentage of coating of particulate in an inline process may be impractical and costly.

### Embodiments of Inline Proppant Coating Apparatus and Methods

While it is to be understood that embodiments taught herein can be used to coat a wide variety of particulates for a wide variety of purposes, including but not limited to, fracturing operations in the oil and gas industry, sand or grit blasting, construction and the like, without intent to so limit the embodiments, the embodiments described below are described in the context of inline coating of proppant for use in fracturing operations.

Further, while a variety of proppants are known to be incorporated with fluids for fracturing operations, such as sand and ceramic beads or particulates, without intent to so limit the embodiments, the embodiments are described herein in the context of sand.

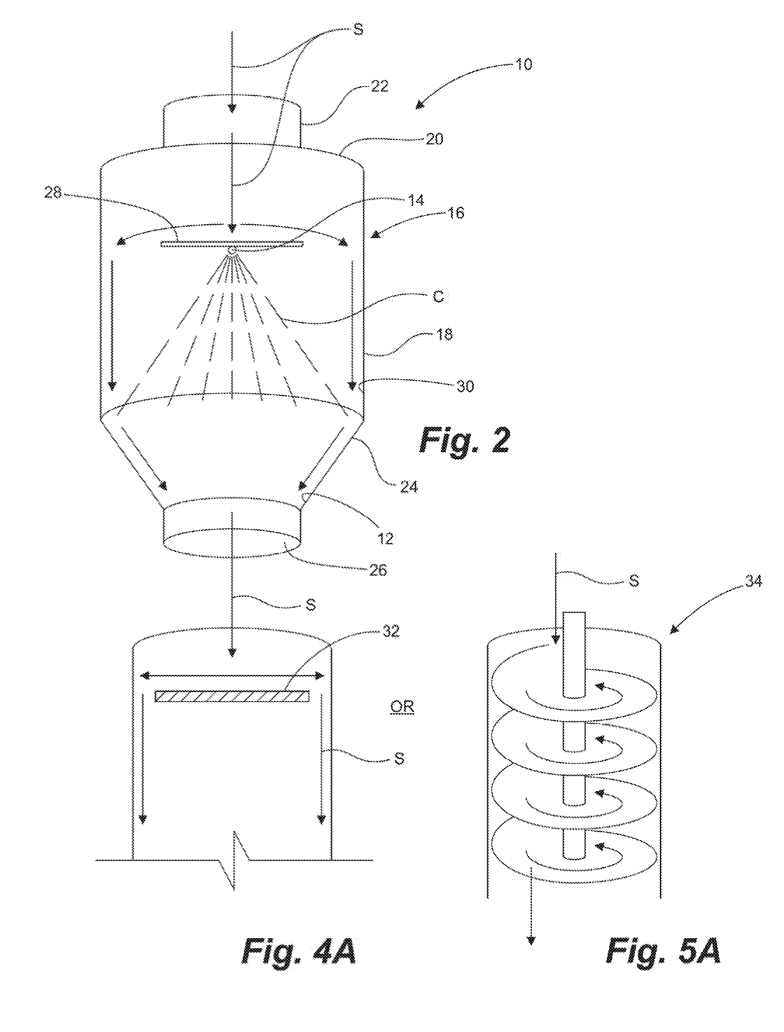

In embodiments taught herein, shown in FIGS. 2 to 8D, sand S is fed into apparatus 10, 100 for coating the sand S with one or more liquid coatings C in a sprayable form. The sand S is caused to spread out and to roll and/or slide down one or more inclined surfaces 12. The sand particles S, moving downward along the one or more inclined surfaces 12, are sprayed thereon with the one or more liquid coatings C.

Generally, the sand S is delivered, such as from a gravity feed, downward for distribution on one or more inclined surfaces 12, the particles of sand S spreading thereon for increasing the surface area, and moving downward therealong. The one or more inclined surfaces 12 are inclined from about 25 degrees to about 75 degrees from horizontal and, more particularly, in embodiments described below, from about 33 degrees to about 75 degrees from horizontal.

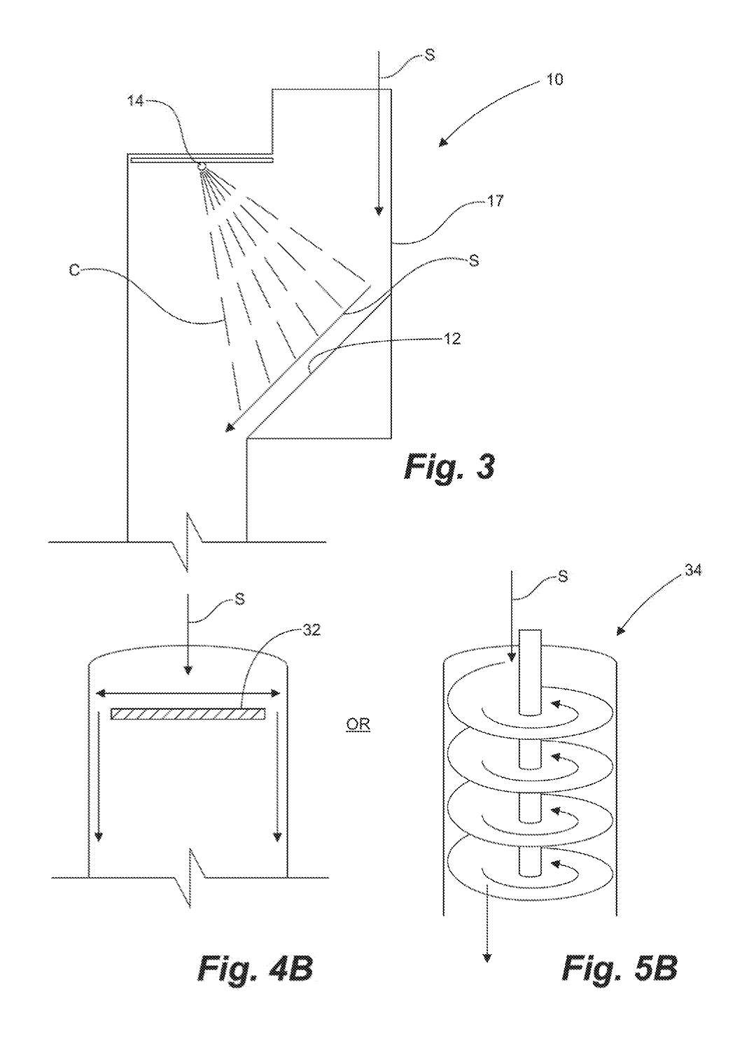

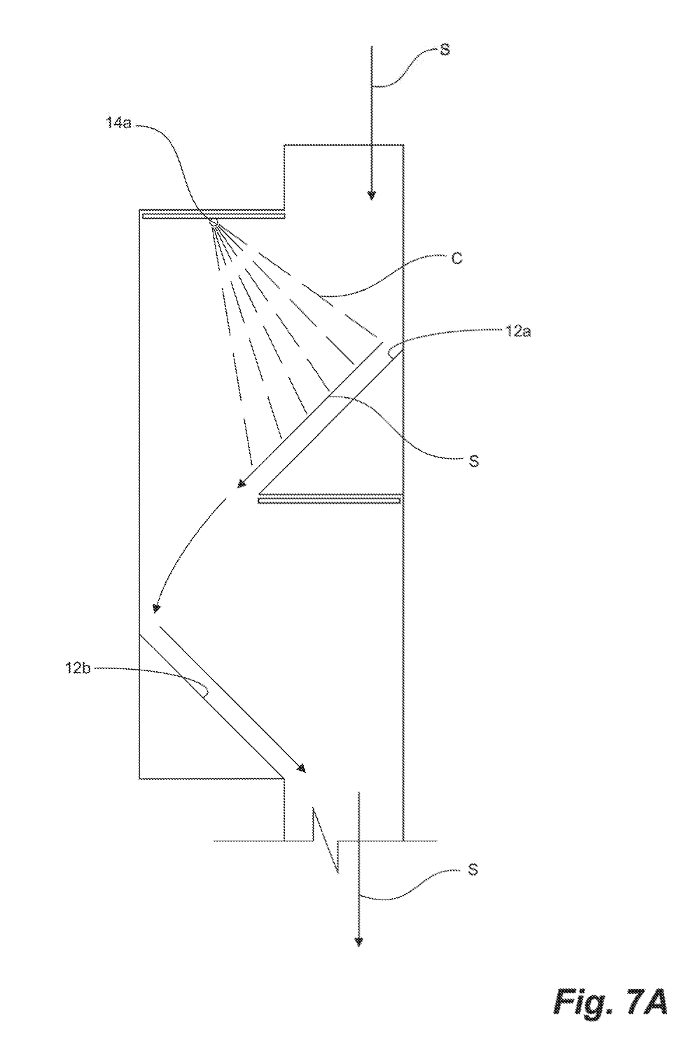

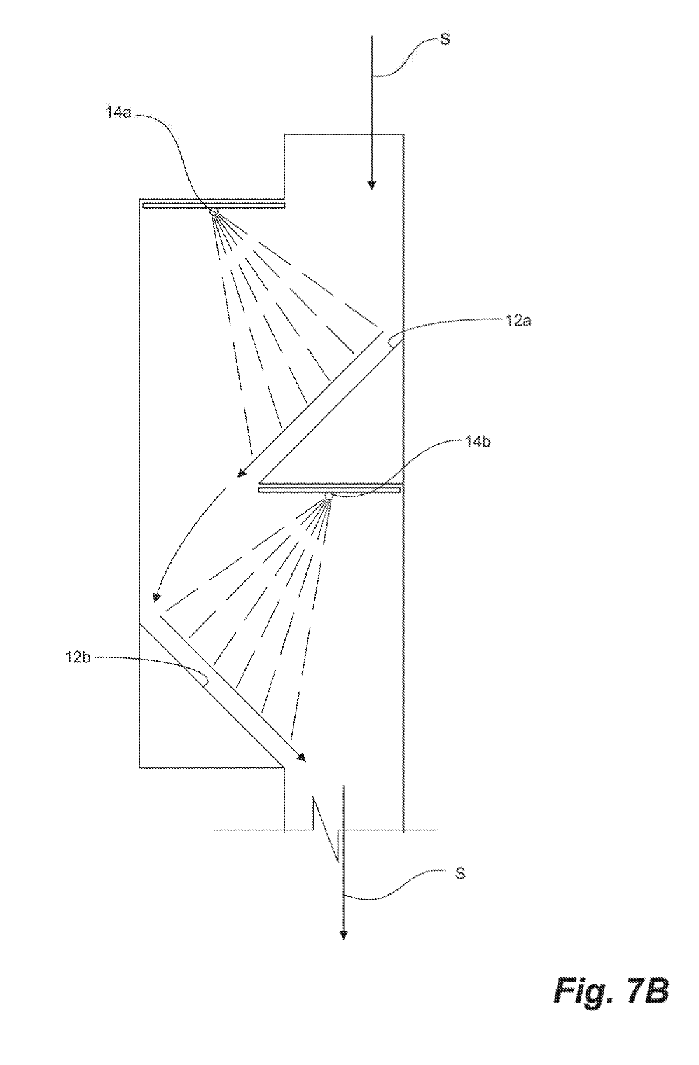

In the case of free-flowing sand S, the angle of repose is generally about 34 degrees from horizontal. Sand on the inclined surface 12, if at or about the angle of repose, is likely to build up along the surface and form a new angled interface at about a dynamic angle of repose. Sand falling on the new angled interface moves downward therealong. At steeper angles, the inclined surface 12 can be textured to provide sufficient friction to cause the sand S thereon to roll rather than to slide therealong. The one or more inclined surfaces 12 can be planar surfaces (FIGS. 3, 7A, 7B) or conical surfaces (FIGS. 2, 6A, 6B, 8A to 8D), such as a funnel shape.

One or more nozzles 14, spaced from the one or more inclined surfaces 12, are directed toward the one or more inclined surfaces 12 for spraying the liquid coating C onto the sand S as the sand S moves therealong. In embodiments, the nozzles 14 are directed from about 45 degrees to about 90 degrees to the inclined surfaces 12. As the particles of sand S roll or otherwise move downwardly along the one or more inclined surfaces 12, it is believed that more of the surfaces of the sand particles S are exposed to the liquid coating C sprayed thereon.

Single Spray Apparatus with Subsequent Particle-to-Particle Transfer

In an embodiment, as shown in FIG. 2, the apparatus 10 comprises a tubular housing 16 having an upper, cylindrical wall 18 formed thereabout, a top 20 end forming an inlet 22 and a lower, radially inwardly-extending conical wall 24, terminating at an outlet 26. The conical wall 24 forms an inclined surface 12. The inlet 22 receives the gravity flow of sand S therein. A distributor 28 is positioned concentrically within the housing 16, downstream from the inlet 22 and in the flow of sand S therein and upstream from the lower conical wall 24 forming the inclined surface 12. The distributor 28 distributes the sand S radially outwardly toward an inner surface 30 of the housing 16 and onto the inclined surface 12.

The one or more spray nozzles 14 are supported in the housing 16, such as downstream of the distributor 28. The one or more nozzles 14 direct the liquid coating C onto the sand S as the sand S is moving downward along the inclined surface 12 toward the outlet 26.

In another embodiment, as shown in FIG. 3, the one or more inclined surfaces 12 comprise at least one generally planar surface located within a housing 17. The one or more nozzles 14 are supported substantially perpendicularly to the planar, inclined surface 12 for directing the liquid coating C onto the planar, inclined surface 12. In an embodiment, the one or more nozzles 14 are spaced across a spray bar (not shown), having a width sufficient to apply the liquid coating C across a width of the planar, inclined surface 12 for coating the sand S moving therealong.

As shown in FIGS. 2 and 3, to meet design coating requirements of greater than 75%, one or more subsequent transfer coating steps to cause particle-to-particle contact act to redistribute the coating C applied to the sand S during the single spray step. A greater percentage of surfaces of sand particles S, un-coated or under-coated as a result of the spray, receive coating C from particles of sand S that are coated or over-coated. As a result the overall percentage of particles of sand S that are at least sufficiently coated to achieve the desired functionality from the liquid coating C is increased.

The one or more subsequent transfer coating steps can be accomplished in a number of ways. The transfer coating step is achieved by movement of the partially coated sand, which causes the particles of sand to rub together or interact in such a way as to transfer the coating therebetween, during a period of time in which the coating remains transferable therefrom.

In embodiments, as shown in FIGS. 4A and 4B, the subsequent transfer step comprises distributing the partially coated sand S exiting the apparatus 10 across a baffle 32.

Alternatively, as shown in FIGS. 5A and 5B, in embodiments the partially coated sand can be discharged onto an auger 34 or other means of creating tortuosity for movement of the sand S therethrough.

In other embodiments, the partially coated sand can be discharged to other downstream apparatus such as a static mixer, to piping, to a blender or the like.

In the embodiments described, the liquid coating C is delivered at a rate such that the sand S remains free-flowing along the one or more inclined surfaces 12 and upon discharge therefrom. Generally, the rate of delivery of the liquid coating C and the droplet size is such that the liquid coating C dries sufficiently on the surface of the sand S to maintain the sand S as free-flowing along the inclined surfaces 12 and following discharge therefrom, however not so dry as to prevent transfer between surfaces of the particles of sand when contact occurs therebetween during the subsequent transfer coating step. The transfer step can occur within seconds, minutes or hours after the spray step. In embodiments, the spray is delivered as a mist.

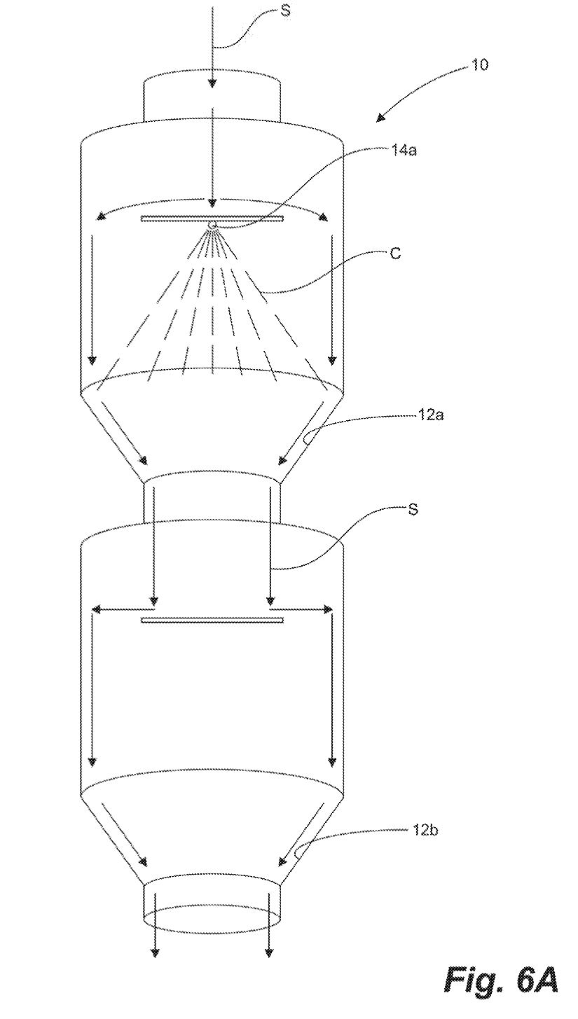

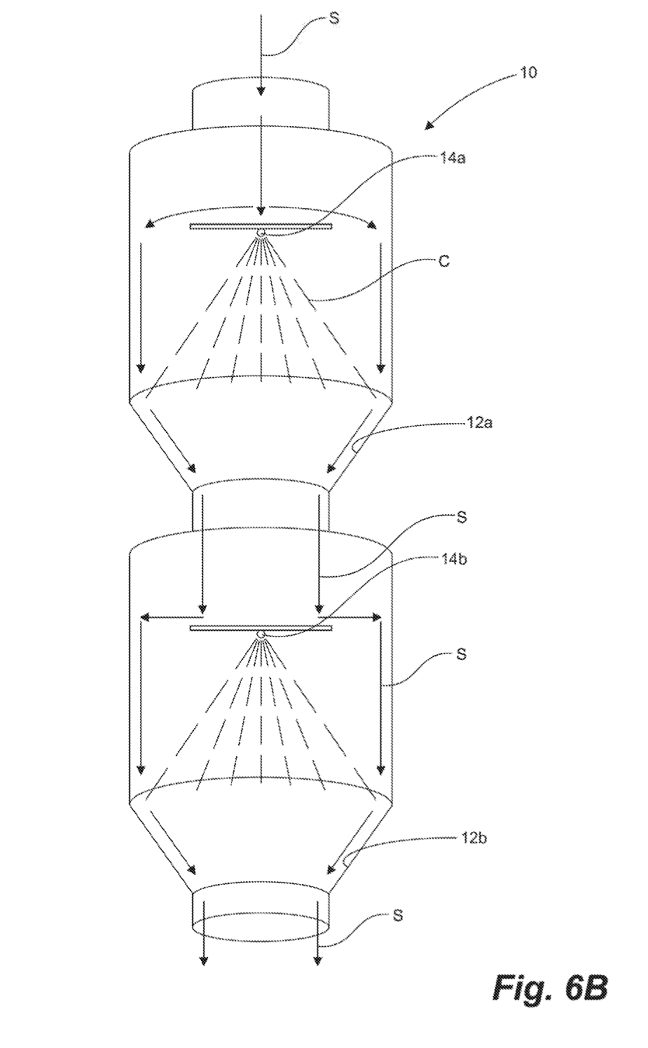

Alternatively, in embodiments shown in FIGS. 6A and 7A, a second inclined surface 12b is added to the apparatus 10 to effect the transfer coating step. The second inclined surface 12b can be a conical surface, as shown in FIG. 6A, or a planar surface 12b as shown in FIG. 7A. The second inclined surface 12b receives the partially coated sand S discharged from the first inclined surface 12a and acts to move the sand therealong for contact between particles of the sand and transferring the coating from particulate-to-particulate therein.

The first and second inclined surfaces 12a, 12b are angled in different directions to cause the partially coated sand S, discharged from the first inclined surface 12a, to move in a different direction on the second inclined surface 12b for exposing different surfaces of the sand S.

### Test Data—Single Spray Apparatus

Testing 1

In tests performed using apparatus according to FIG. 2, a hydrophobicizing composition comprising at least 90% oil and 10% siloxane was sprayed onto 30/50 mesh sand. The liquid coating C was applied at a rate of about 0.08 wt %. A simple float test was used to visually determine the percentage of the sand S that was coated, after discharge from the apparatus 10 and without a subsequent transfer step. The percentage of the sand that floats when placed in water approximates the amount of sand that is sufficiently coated with the hydrophobicizing composition.

Compared to a control which has no coating applied, and in which substantially all of the sand settles to the bottom and does not float, only about 50% of the sand appears not to float. Therefore it appears that about 50% of the sand is coated sufficiently to hydrophobicize the sand and cause the sand to float.

Applicant believes that the transfer coating step, which would follow according to the embodiments described above, would be sufficient to transfer enough coating from particulate-to-particulate to increase the overall coating to result in at least 75% coating of the sand.

Testing 2

Apparatus 10 as shown in FIG. 2 was used to coat sand with hydrophobicizing compositions using the following protocols.

Testing Protocol

Function Test Single Spray Nozzle and Calibrate Chemical Rates:
1. rig up a chemical van with appropriate hoses;
2. pump fresh water and visually inspect function of the spray nozzle at all required chemical rates. Add a back pressure valve where required to steady the chemical rates.
3. perform a bucket test using the coating composition to confirm the chemical rates and record the rates.

Establish Sand Flow Rates and Overhead Valve Positions:
1. rig up the coating apparatus onto an overhead spout.
2. load about 3 to about 5 tons of sand into the overhead bin.
3. position end dump under the coating apparatus.
4. setup to time sand displacement.
5. open valve to predetermined position emptying sand from overhead into the end dump and establish a sand flow rate.
6. leaving the overhead valve open
7. mark the position of the overhead valve and record the rate.

Repeat steps 2 to 6 until markings are in place for approximate rates of 1.5, 2, 2.5 and 3 ton/min.

Test Coating Efficiency and Determine PASS/FAIL of Flow Through Rates:
1. reload overhead with about 3 to about 5 tons of proppant;
2. position an end dump under the coating apparatus;
3. rig up chemical hoses to the coating apparatus outfitted with a flow tee (flow tee is used for redirecting chemical flow while establishing chemical flow rate and preventing excess flow after each test);
4. with coating apparatus in place, perform another bucket test with coating composition as hydrostatics may have adjusted the rates;
5. set up to time the sand displacement;
6. establish chemical rate at chemical van for first sand flow rate;
7. reset chemical total in chemical van and redirect chemical to coating apparatus;
8. open overhead valve to predetermined rate position;
9. collect sand sample(s) from the exit of the coating apparatus;
10. shut down sand and chemical and record sand and chemical volumes;
11. visually inspect sand coating distribution of proppant using a bubbly sand test, which is a visual float test, to establish PASS/FAIL;
12. repeat procedures 6-12 for all sand flow-through rates and record all data

Testing of Scaled-Up Coating Apparatus Having Single Spray Step

Apparatus, according to FIG. 2, was tested to determine the maximum sand flow rate in tonne/min possible to achieve a maximum coating of about 70-80%. Different liquid coatings, in this case hydrophobicizing compositions, were tested for coating a proppant, such as 30/50 US mesh size or 20/40 US mesh size proppant. Further, apparatus 10 having different throughput capacities were tested.

Two different liquid coatings C were tested; Composition A (a pre-coated oil-based, siloxane-containing hydrophobicizing composition) and Composition B (an oil-free, water-based, silane-containing hydrophobicizing composition).

About 0.6 L/tonne of A and about 0.8 L/tonne of B were tested using a first apparatus 10 having a capacity of about 5 tonne/minute and a second apparatus 10 having a capacity of about 3 tonne/minute. Proppant used was a Tier 1, 20/40 US mesh size sand.

Proppant flow through the apparatus 10 was first calibrated and a color code assigned to the opening valve at the bottom of a feeding silo as noted in Table 1 below:

TABLE 1

| | | | | | | | Proppant |
|---|---|---|---|---|---|---|---|
| Color | | | | | | | rate |
| Code | Line | Time 1 | Time 2 | Time 1 | Time 2 | Tons | Tonne/min |
| Green | 1 | 3:37 | 3:38:33 | 3.62 | 3.64 | 5 | 1.38 |
| | 2 | 2:52 | 2:51:22 | 2.87 | 2.86 | 5 | 1.75 |
| White | 3 | 2:13 | 2:11:04 | 2.22 | 2.18 | 5 | 2.26 |
| Yellow | 4 | 1:52:40 | 1:53 | 1.88 | 1.88 | 5 | 2.66 |
| Red | 5 | 1:41 | 1:40:22 | 1.68 | 1.67 | 5 | 2.97 |

### Coating Results:

### Oil-Based Composition A Testing:

Testing according to the test coating efficiency protocol as outlined above was performed using the oil-based hydrophobizing composition A, in the 3 Tonne/min apparatus and in the 5 Tonne/min apparatus. The results were as follows:

TABLE 2
3 Tonne/min Unit

| | | | Chem | | 3 Tonne/min | 3 Tonne/min |
|---|---|---|---|---|---|---|
| Stroke | Valve | Rate | Conc | | no mixing | with mixing* |
| position | position | T/min | L/t | L/min | Pass/Fail | Pass/Fail |
| Green | Line1 | 1.38 | 0.6 | 0.83 | Fail | Pass |
| | Line 2 | 1.75 | 0.6 | 1.05 | Fail | Pass - not as |
| | | | | | | good |
| White | Line 3 | 2.26 | 0.6 | 1.35 | Fail | Fail |
| Yellow | Line 4 | 2.66 | 0.6 | 1.60 | | |
| Red | Line 5 | 2.97 | 0.6 | 1.78 | | |
| | Line 6 | 3.49 | 0.6 | 2.09 | | |

*shaking of sample bottle manually

It was noted that coating of samples taken from the exit of the apparatus 10 was visually inconsistent. Free-flowing sand samples, taken off an end dump, while pouring sand onto a belt, were mixed by shaking. The shaking represented a worst case scenario in the field during fracturing wherein the sand had only one mix cycle after the coating apparatus 10. In other words, the samples were subjected to a single transfer step as described herein.

Most samples, when shaken after sampling to effect particulate-to-particulate transfer of coating prior to addition to water to visually determine the percentage of sand which floats, showed a visual improvement in the percentage of sand which floated, indicating coating of sand within the target range of about 70-80%. Applicant believes the additional shaking mimics transfer steps, such as the downstream handling of the sand prior to storage or preparation of the fracturing fluid and further particulate-to-particulate transfer of coating as a result thereof.

TABLE 3
5 Tonne/min Unit

| | | | Chem | | 5 Tonne/min | 5 Tonne/min |
|---|---|---|---|---|---|---|
| Stroke | Valve | Rate | Conc | | no mixing | with mixing* |
| position | position | T/min | L/t | L/min | Pass/Fail | Pass/Fail |
| Green | Line1 | 1.38 | 0.6 | 0.83 | | |
| | Line 2 | 1.75 | 0.6 | 1.05 | | |
| White | Line 3 | 2.26 | 0.6 | 1.35 | Fail | Pass |
| Yellow | Line 4 | 2.66 | 0.6 | 1.60 | Fail | Pass |
| Red | Line 5 | 2.97 | 0.6 | 1.78 | Fail | Pass |
| | Line 6 | 3.49 | 0.6 | 2.09 | Fail | |

*shaking of sample bottle manually

It was again noted in this test that coating of the samples from the exit of the coater unit was visually inconsistent. Samples, taken from inside a bin, after dumping therein to represent a single transfer step, showed improvement in coating.

Further, as with the results from the 3 Tonne/min apparatus, samples from the bin provided the best results after shaking the sample bottles, prior to adding water for determining the percentage coating, to further distribute the hydrophobicizing composition on the free-flowing sand.

Low chemical rates of below 2 L/min were determined to be too low for the nozzles to deliver reliably.

### Water-Based Composition B Testing:

Testing according to the test coating efficiency protocol as outlined above was performed using the water-based hydrophobizing composition B, in the 3 Tonne/min apparatus and in the 5 Tonne/min apparatus. The results are shown in Tables 4 and 5 below.

TABLE 4
3 Tonne/min unit

| | | | Chem | | 3 Tonne/min | 3 Tonne/min |
|---|---|---|---|---|---|---|
| Stroke | Valve | Rate | Conc | | no mixing | with mixing* |
| position | position | T/min | L/t | L/min | Pass/Fail | Pass/Fail |
| Green | Line1 | 1.38 | 0.8 | 1.10 | Fail | Pass |
| | Line 2 | 1.75 | 0.8 | 1.40 | | |
| White | Line 3 | 2.26 | 0.8 | 1.80 | Fail | Fail |
| Yellow | Line 4 | 2.66 | 0.8 | 2.13 | | |
| Red | Line 5 | 2.97 | 0.8 | 2.38 | | |
| | Line 6 | 3.49 | 0.8 | 2.79 | | |

*shaking of sample bottle manually

TABLE 5
5 Tonne/min unit

| | | | Chem | | 5 Tonne/min | 5 Tonne/min |
|---|---|---|---|---|---|---|
| Stroke | Valve | Rate | Conc | | no mixing | with mixing* |
| position | position | T/min | L/t | L/min | Pass/Fail | Pass/Fail |
| Green | Line1 | 1.38 | 0.8 | 1.10 | | |
| | Line 2 | 1.75 | 0.8 | 1.40 | | |
| White | Line 3 | 2.26 | 0.8 | 1.80 | Fail | Pass |
| Yellow | Line 4 | 2.66 | 0.8 | 2.13 | | |
| Red | Line 5 | 2.97 | 0.8 | 2.38 | Fail | Pass |
| | Line 6 | 3.49 | 0.8 | 2.79 | | |

*shaking of sample bottle manually

It was noted for both the 3 Tonne/min and 5 Tonnes/min apparatus 10 that shaking sample bottles pulled directly out of the bin following discharge from the apparatus 10 was again required to distribute product sufficiently to meet design requirements of about 70-80% coating.

### Conclusion:

It was concluded that apparatus capable of providing only a single spray step directed to the sand flowing on the inclined surface 12 requires one or more subsequent transfer steps to coat the particles of sand to achieve the at least about 70 to 80% coating required to suppress dust and to hydrophobicize the sand. This is true for both the oil-based hydrophobicizing composition tested and the water-based hydrophobicizing composition tested.

Embodiments of a Dual Spray Coating Apparatus without Subsequent Transfer Step

While one or more transfer coating steps, following spraying the liquid coating onto the sand S, achieves a level of coating of particulate of 75% or greater, incorporation of additional apparatus for the transfer steps, in an inline process, may be impractical and add to the overall capital costs. Further, the time required to perform the one or more transfer steps may impact the timing of delivery of the coated particulate and increase the operational costs.

Having reference to FIGS. 6B, 7B and 8A to 8D, embodiments of apparatus 100 described below effectively coat the sand S to greater than 75% in a single pass through the apparatus 100 without apparatus, such as baffles or augers or the like to provide subsequent particulate-to-particulate transfer coating steps.

The apparatus 10, 100 comprises first and second inclined surfaces 12a, 12b. Liquid coating C is sprayed onto both first and second inclined surfaces 12a, 12b while the sand S moves therealong. A portion of the total amount of the liquid coating C is applied to the sand S moving along the first inclined surface 12a. A balance of the liquid coating C is sprayed onto the sand S moving along the second inclined surface 12b. The total amount of liquid coating C delivered to the sand S remains the same as in embodiments using the single spray.

As with the embodiments previously described, the first and second inclined surfaces 12a, 12b are angled in different directions. Sand S delivered at about an apex of the inclined surfaces 12a, 12b, moves therealong. The partially coated sand S, discharged from the first inclined surface 12a, moves downwardly in the different direction on the second inclined surface 12b for exposing different surfaces of the sand S that were not sprayed on the first inclined surface 12a. Thus, the liquid coating C sprayed on the second inclined surface 12b and coating the exposed surfaces, results in a greater percentage of coating of the sand S.

In the embodiment shown in FIG. 6B, the first and second inclined surfaces 12a, 12b are provided by using two, stacked apparatus 10. The discharge outlet 26 from an upper apparatus 10 discharges to the inlet 22 of the lower apparatus 10.

In the embodiment shown in FIG. 7B, the second inclined surface 12b, used in the single spray embodiment to provide the transfer step, is sprayed with the balance of the liquid coating C.

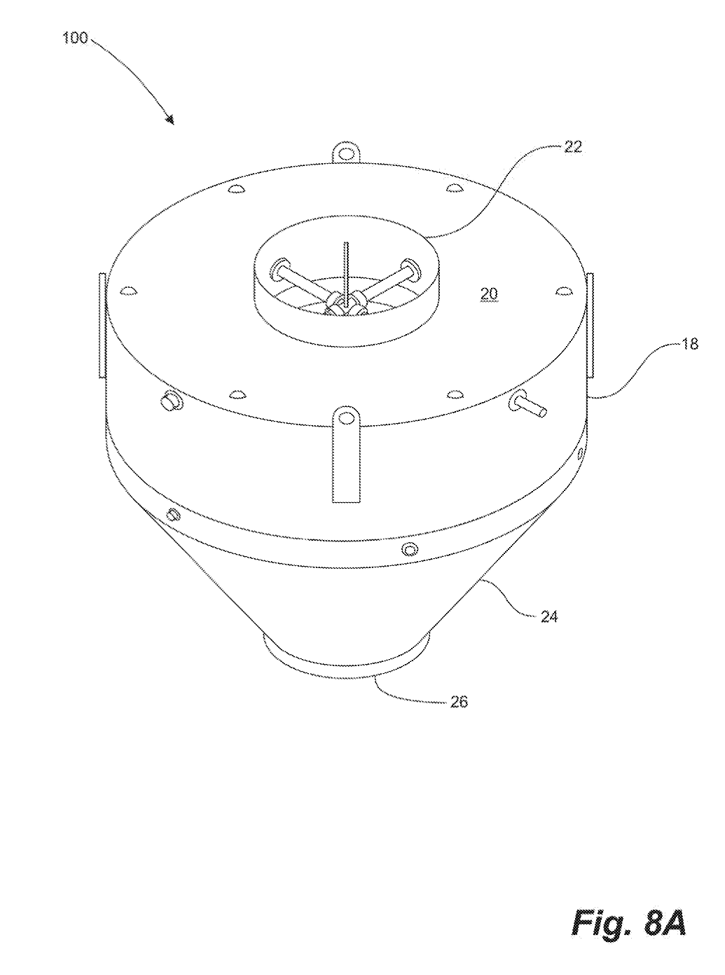

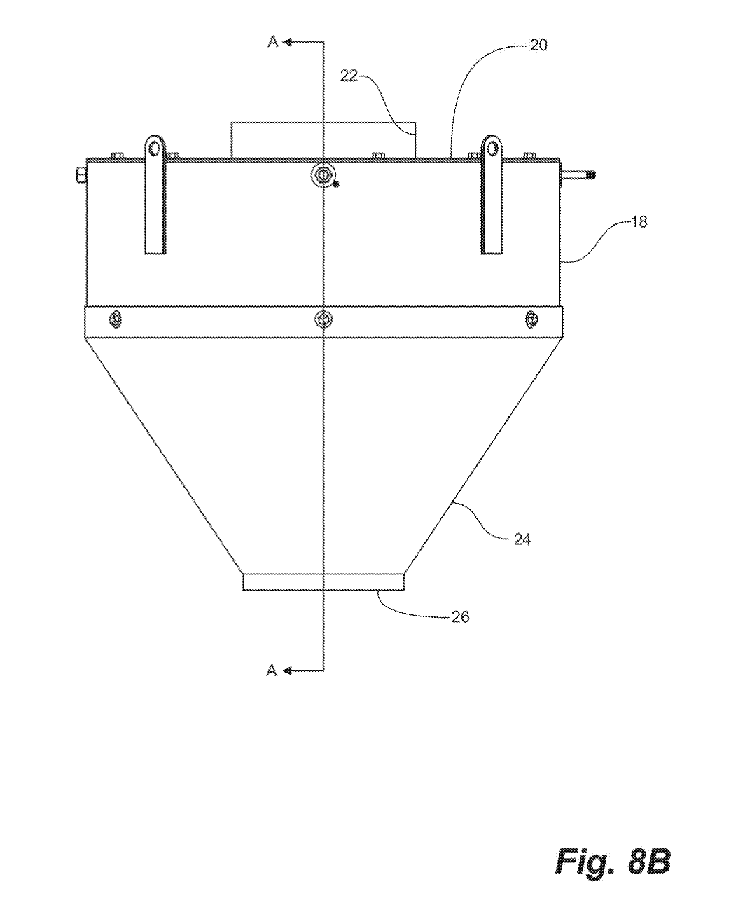

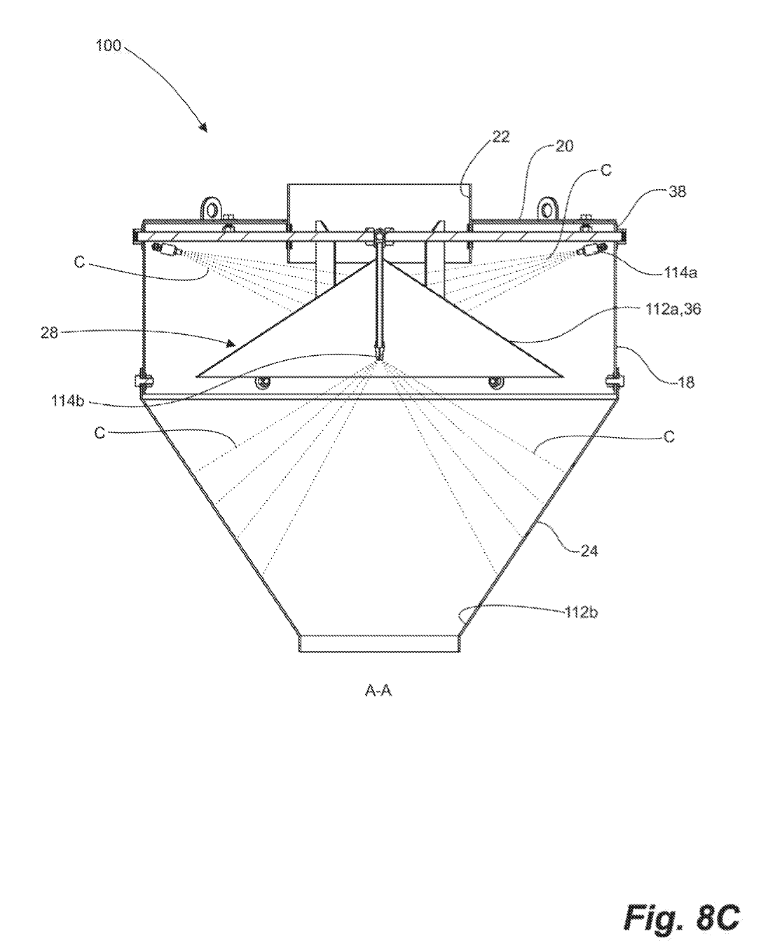

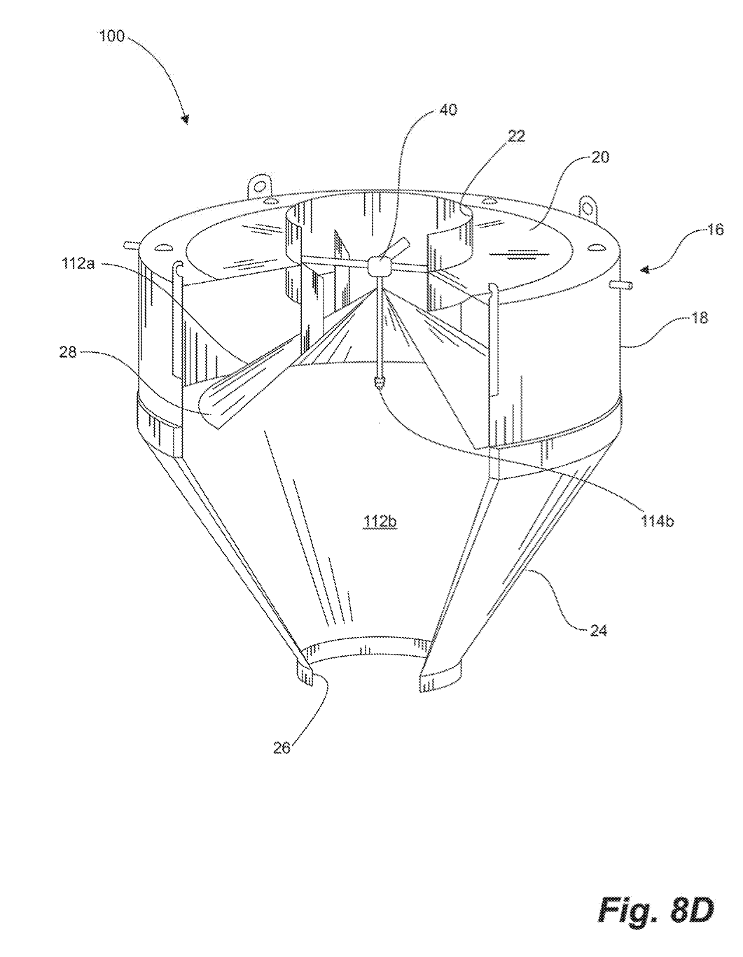

Having reference to FIGS. 8A-8D, in an embodiment, like the previously described apparatus 10, a coating apparatus 100 comprises the tubular housing 16 having the cylindrical wall 18, a top 20 forming the inlet 22, the radially inwardly-extending lower conical wall 24 and the discharge outlet 26.

A hollow cone-shaped member 28, supported within the housing 16 downstream from the inlet 22 and upstream from the lower conical wall 24 acts as a distributor 28 for receiving the sand S, and distributing the sand S over an external surface 36 thereof. The external surface 36 forms a first upper inclined surface 112a for intercepting the sand S as it falls through the inlet 22. The lower conical wall 24 forms a second, lower inclined surface 112b. The upper and lower inclined surfaces 112a, 112b are inclined in different directions. The first inclined surface 12a directs the sand S downwardly in a first direction away from the inlet 22 and feed of particulates thereto, such as outwardly towards the cylindrical wall 18. The lower inclined surface 112b, directs the sand, received from the upper inclined surface 112a, downwardly in a second direction toward the inlet 22 and the feed thereto, such as inwardly and toward the discharge outlet 26.

Further, as with the previous embodiments, the first and second inclined surfaces 112a, 112b can be inclined from about 25 degrees to about 75 degrees.

One or more first nozzles 114a, best seen in FIG. 8C, are supported adjacent a top 38 of the upper cylindrical wall 18 and are directed toward the first inclined surface 112a. The one or more second nozzles 114b are supported beneath the distributor 28 and directed toward the second inclined surface 112b. A header 40, as best seen in FIG. 8D, feeds the liquid coating C from a supply thereof to the one or more first and second nozzles 114a, 114b.

In an embodiment, the first inclined surface 112a is angled about 33 degrees from horizontal, about 57 degrees from vertical and has an included angle of about 114 degrees The second inclined surface 112b is angled about 56 degrees from horizontal, about 31 degrees from vertical and has an included angle of about 68 degrees.

In the exemplary embodiment shown in FIGS. 8A-8D, apparatus 100 and methods according to embodiments taught herein, are used to coat sand S for use in preparing a fracturing fluid and/or for suppressing dust during handling of the sand S. The apparatus 100 is capable of producing from about 2 tonnes/min to about 6 tonnes/min of sand coated at a percentage greater than 75%. Optimally, the apparatus 100 is capable of producing from about 2 to about 3 tonnes/min of sand coated at a percentage of about 85% or greater in a single pass.

Applicant produces a variety of hydrophobicizing compositions useful for increasing the functionality of a proppant. More particularly, the hydrophobicizing compositions cause the proppant to float within the fracturing fluid and also act to suppress dust when handling the proppant. The hydrophobicizing compositions are described in Applicant's co-pending applications and issued patents listed below and incorporated by reference herein in their entirety:

U.S. Pat. No. 7,723,274; Canadian Application 2,545,563; US published application 20100197526; PCT published application WO2006/116868; PCT published application WO2007/033489; U.S. Pat. No. 8,236,738; Canadian Patent 2,684,966; U.S. Pat. No. 8,800,658; Canadian Patent 2,848,264; US published application 20140243245; PCT published application WO2008/131540; U.S. Pat. No. 8,105,986; Canadian Patent 2,683,516; US published application 20120071371; PCT published application WO2008/124919; Canadian Patent 2,693,427; US published application 20100256024; PCT published application WO2009/009886; US published application 20120322697; Canadian application 2,690,768; Canadian application 2,787,132; PCT published application WO2011/08856; Canadian application 2,772,833; US published application 20120267112; PCT published application WO2011/026232; Canadian Patent 2,735,428; US published application 2012067594; US published application 20150252254; Canadian application 2,845,069; Canadian application 2,883,811; US published application 20150307772; Canadian application 2,889,374; US published application 20160017213; Canadian application 2,897,441; Canadian application 2,877,025, Canadian application 2,917,288; PCT published application WO2016109901; Canadian application 2,880,646; Canadian application 2,919,277; and US published application 20160222282.

Applicant believes that applying hydrophobicizing coatings C, according to the patents and applications listed above, at a rate from about 0.03 wt % to about 0.15 wt % maintains the sand S as free-flowing throughout the coating process and thereafter. The sand S is supplied to the apparatus 100 at a rate of about 2 to about 6 tonnes per minute, Further, the hydrophobicizing coating C, applied at that rate, is sufficient to coat 75% or greater of the sand S, which is suitable for sand bulk loading for a fracturing operation.

As the process, using embodiments of the apparatus 100 as taught herein, is an inline process, coated sand S is discharged directly from the apparatus 100 to storage, for transport or directly to the wellsite at a rate sufficient to meet the downstream demands. As there are no additional drying steps required and the throughput of the apparatus 100 to produce a usable product is from about 2 tonnes/min to about 6 tonnes/min, the process is capable of satisfying typical downstream demands for a fracturing operation, both efficiently and cost-effectively.

In embodiments according to FIGS. 8A-8D, the flow rate of liquid coating C delivered to the first and second inclined surfaces 112a, 112b can be balanced. For example, if X liters per ton of sand is required, the one or more first nozzles 114a are sized so that the aggregate flow rate is X/2. The one or more second nozzles 114b are sized so that the aggregate flow rate is X/2.

In embodiments, of the total amount of liquid coating C delivered to the sand S, the ratio of liquid coating C delivered from the one or more first nozzles 114a to the liquid coating C delivered from the one or more second nozzles 114b is in a range from about 4:1 to about 1:4.

By way of example, in the embodiment shown in FIGS. 8A-8D, two 303 stainless steel, flat spray nozzles having a spray angle of 120°, available as product #3403K78 from McMaster-Carr of Elmhurst, Ill., USA, are used as the one or more first spray nozzles 114a. A single, stainless steel, hollow cone pattern, misting nozzle having a spray angle of 160°, available as product #3178K54 from McMaster-Carr, is used as the second spray nozzle 114b. The flow rate specifications, rated for air and/or thin liquids, for each of the nozzles are listed in the Table 6 below.

TABLE 6

| | Flat Spray Nozzle | Hollow Cone Pattern | |
|---|---|---|---|
| | 3403K78 | Nozzle 3178K54 | |
| Pressure (psi) | Flow rate (gpm) | Flow rate (gph) | Flow rate (gpm) |
| 20 | 0.3 | — | — |
| 40 | 0.5 | 9.49 | 0.16 |
| 100 | 0.7 | 15 | 0.25 |
| 500 | — | 33.54 | 0.56 |
| 1000 | 2.5 | — | — |

Applicant understands the viscosity of the hydrophobicizing composition is greater than the viscosity of air or thin liquids and therefore the manufacturer's specifications are provided as a guideline only.

Using the nozzles as described above in the embodiment of FIGS. 8A-8D, the ratio of chemical composition delivered to the first inclined surface 112a is about 3 times that delivered to the second inclined surface 112b.

Testing Dual Spray Apparatus without Transfer Step

Sampling and Testing Protocol

Testing of samples, coated using apparatus according to FIGS. 8A-8D, was done with gas chromatography having a flame ionization detector (GC-FID). The sand S was coated with a hydrophobicizing composition comprising an oil/siloxane blend.

Samples (50 grams) taken at various locations within the sand S leaving the discharge outlet 26 of the apparatus 100 were collected in glass bottles. Iso-octane (2,2,4 trimethylpentane) (50 grams) was added to each sample and to a set of lab prepared standards of sand S with known percentages of coating, such as 0 L/tonne, 0.5 L/tonne and 1.0 L/tonne. The sample bottles were shaken by hand for one minute and were allowed to stand overnight. The samples were then spiked with 0.5 vol % dodecane.

The iso-octane fraction of each of the samples was run through the GC-FID and the peak area of the spike associated with the coating composition C was compared to the peak area of the spiked dodecane of known concentration for that sample to determine the amount of the coating composition C that was coated on the sand S. In the case of the composition used for the testing, the spike associated therewith was a tridecane (C13). As one of skill would understand each coating composition would have a unique signature.

Test Results

Five samples were taken directly from the sand S being discharged at a rate of 2.5 tonne/min after coating with about 0.8 L/tonne of the oil/siloxane blend hydrophobicizing composition, in the apparatus 100 according to FIGS. 8A-8D.

For the purposes of comparison to samples which have been subjected to a subsequent transfer step, five samples were also taken from a bin to which the sand S, discharged from the apparatus 100, was transferred. The transfer steps comprised lifting the sand S from a hopper, in which the coated sand S from the apparatus 100 was first collected and transferring the coated sand S by belt to the bin. The sand S was dropped from an end of the belt into the bin.

The samples were processed as described above and the results following GC-FID analysis are shown in Table 7 below.

TABLE 7

| | Results in L/tonne | | Results in L/tonne |
|---|---|---|---|
| Samples | from discharge | Samples | from bin |
| 1 | 0.77 | 1 | 0.81 |
| 2 | 0.55 | 2 | 0.79 |
| 3 | 0.79 | 3 | 0.69 |
| 4 | 0.78 | 4 | 0.75 |
| 5 | 0.60 | 5 | 0.78 |
| Average | 0.70 | Average | 0.76 |
| SD | 0.10 | SD | 0.04 |
| Avg % coated | 87.5% | Avg % coated | 95% |

It was concluded that spraying the sand S as it was moved along the first and second inclined surfaces 112a, 112b was sufficient to achieve a percentage coating of greater than 75%, and more particularly greater than 85%, without a requirement for a subsequent transfer step.

Further, it was observed that the percentage coating of the sand increased as the coated sand was moved or bagged for use thereafter, likely as a result of particulate-to-particulate contact.

Embodiments in which an exclusive property or privilege is claimed are defined as follows:

1. Apparatus for coating particulates with a liquid coating comprising:
a first inclined surface for receiving the particulates distributed thereon from a feed thereto and moving the particulates downwardly therealong in a first direction away from the feed;
one or more first sprays for directing a portion of the liquid coating onto the first inclined surface for coating at least a portion of the particulates moving in the first direction therealong;
a second inclined surface for receiving the partially coated particulates discharged from the first inclined surface and moving the particulates downwardly therealong in a second direction toward the feed; and
one or more second sprays for directing a balance of the liquid coating onto the second inclined surface for coating at least a portion of the particulates moving in the second direction therealong for discharge of free-flowing, coated particulates from the second inclined surface;
wherein the liquid coating is delivered to the particulates at a flow rate of between about 0.03 wt % to about 0.15 wt %.

2. The apparatus of claim 1 wherein a ratio of the portion of the liquid coating delivered from the one or more first nozzles and the balance delivered by the one or more second nozzles is from about 4:1 to about 1:4.

3. The apparatus of claim 1 wherein the particulates are fed to the apparatus at from about 2 tonnes per minute to about 6 tonnes per minute.

4. The apparatus of claim 1 wherein the throughput is from about 2 tonnes per minute to about 6 tonnes per minute and wherein the particulates are coated to greater than about 75%.

5. The apparatus of claim 1 wherein the throughput is from about 2 tonnes per minute to about 3 tonnes per minute and wherein the particulates are coated to greater than about 85%.

6. The apparatus of claim 1 wherein the first inclined surface is a conical surface or a planar surface and wherein the second inclined surface is a conical surface or a planar surface.

7. The apparatus of claim 1 further comprising:
a tubular housing having
an upper cylindrical wall;
a top having an inlet formed therein for receiving the feed of the particulates;
a lower, radially inwardly-extending conical wall extending from a bottom of the cylindrical wall; and
a discharge outlet formed in the lower conical wall for the discharge of the free-flowing coated particulates therefrom;
a hollow conical distributor supported concentrically within the housing downstream from the inlet and upstream from the lower conical wall for forming the first inclined surface;
one or more first nozzles supported in the housing for directing the one or more first sprays onto the first inclined surface; and
one or more second nozzles supported in the housing for directing the one or more second sprays onto the second inclined surface,
wherein the lower radially inwardly-extending conical wall forms the second inclined surface.

8. The apparatus of claim 1 wherein the first and second inclined surfaces are inclined downwardly from about 25 degrees to about 75 degrees from horizontal.

9. The apparatus of claim 1 wherein the first and second inclined surfaces are inclined downwardly from about 33 degrees to about 57 degrees from horizontal.

10. The apparatus of claim 1 wherein the first inclined surface is inclined downwardly at about 33 degrees from horizontal and the second inclined surface is inclined downwardly at about 57 degrees from horizontal.

11. The apparatus of claim 7 wherein the one or more first and second nozzles are directed from 45 degrees to 90 degrees toward the first and second inclined surfaces.

12. The apparatus of claim 7 wherein the one or more first nozzles are flat-pattern spray nozzles having a spray angle of about 120 degrees.

13. The apparatus of claim 7 wherein the one or more second nozzles are hollow cone pattern nozzles having a spray angle of about 160 degrees.

14. The apparatus of claim 7 wherein the one or more second nozzles are supported below the hollow conical distributor.

15. The apparatus of claim 1 wherein the particulate is proppant and the coating composition is a hydrophobicizing composition.

16. The apparatus of claim 15 wherein the proppant is sand.

17. The apparatus of claim 1 wherein the particulate is sand and the coating composition is a hydrophobicizing composition.

18. The apparatus of claim 1 wherein dust produced from the particulate is reduced by about 85% after coating.

19. The apparatus of claim 1 wherein the liquid coating is sprayed on the particulates as a mist.

20. A method of coating particulates with a liquid coating comprising:
feeding the particulates onto a first inclined surface for distributing the particulates thereon, the particulates moving downwardly therealong in a first direction away from the feed;
coating at least a portion of the particulates with the liquid coating as the particulates move downwardly along the first inclined surface;
discharging the particulates from the first inclined surface to a second inclined surface for moving the particulates downwardly therealong in a second direction toward the feed; and
coating at least a portion of the particulates with the liquid coating as the particulates move downwardly along the second inclined surface for discharge therefrom, greater than about 75% of the particulates being coated.

21. The method of claim 20 wherein the coating of the at least a portion of the particulates on the first and second inclined surfaces comprises:
delivering the coating to the particulates at a flow rate of between about 0.03 wt % to about 0.15 wt %.

22. The method of claim 20 wherein the coating of the at least a portion of the particulates on the first and second inclined surfaces comprises:
spraying a portion of the liquid coating onto the first inclined surface for coating at least a portion of the particulates moving therealong; and
spraying a balance of the liquid coating onto the second inclined surface for coating at least a portion of the particulates moving therealong.

23. The method of claim 22 comprising
spraying the liquid coating onto the first inclined surface and the second inclined surface at a ratio of from about 4:1 to about 1:4.

24. The method of claim 20 wherein the feeding the particulates comprises:
feeding the particulates at from about 2 tonnes per minute to about 6 tonnes per minute.

25. The method of claim 20 wherein the discharging coated particulates from the second inclined surface comprises:
discharging from about 2 tonnes per minute to about 6 tonnes per minute of coated particulates.

26. The method of claim 20 wherein the discharging coated particulates from the second inclined surface comprises:
discharging from about 2 tonnes per minute to about 3 tonnes per minute of coated particulates; and
wherein the coated particulates are coated to greater than about 85%.

27. The method of claim 20 wherein the liquid coating is delivered to the particulates as a mist.
